(19) United States
(12) Patent Application Publication
(10) Pub. No.: US 2004/0148641 A1
(43) Pub. Date: Jul. 29, 2004

(54) Television systems

(76) Inventor: Jonathan P. V. Drazin, Whitchurch-on-Thames (GB)

Correspondence Address: Laura A Sheridan, Fish & Neave, 1251 Avenue of the Americas, New York, NY, 10020-1104, US

(21) Appl. No.: 10/468,946

(22) PCT Filed: Feb. 25, 2002
(86) PCT No.: PCT/GB02/00829

(30) Foreign Application Priority Data
Feb. 23, 2001 (GB) 0104521.0

(51) Int. Cl. H04N 7/16

(52) U.S. Cl. 725/141; 725/133

(57) ABSTRACT

A television system comprises a display (1) for displaying a user interface, the interface having a system allowing a user to select additional information. The television system includes a receiver for receiving a user selection for additional information, the additional information being provided from a secondary broadcast. The selected information is extracted and presented to the user, preferably as part of the user interface shown on the display (1).

The present invention relates to television systems, in particular television systems that use teletext or other secondary broadcast information services.

TV teletext information services (Teletext Spec ETSI ETS 300 706) have been in popular use since the early 1980s. These services entail the reception and decoding of data within the vertical blanking interval. (VBI) of PAL or SECAM analogue TV broadcasts. More recently, standards for digital TV broadcast information services have been extended to carry both the conventional teletext services (DVB Teletext Extensions, ETSI EN 300 472 v1.2.2) and newer interactive presentation formats such as MHEG-5, Java and HTML (MHP, ETSI TS 102812 v1.1.1). This document describes two variations of the invention designed to handle both analogue VBI and digital data broadcasts.

In all these cases the user tunes manually to a specific TV or information service channel to receive the information. This causes the currently viewed TV programme to be interrupted which is often a source of inconvenience to TV viewers. Moreover, the titles and contents of these information services are repeatedly re-broadcast as rotating data “carousels” that result in large bandwidth requirements to the broadcaster and delays experienced by the user while the specific content of interest is waited for and downloaded.

The usage and bandwidth limitations of carousel broadcast services are widely appreciated. One popular solution is to provide a process in the receiving device whereby service content of possible interest is downloaded and stored in advance of possible selection for display by a user: so called “cacheing” of broadcast data. This eliminates the delays associated with waiting for the desired content to be broadcast and allows a carousel of content to be broadcast more slowly, reducing bandwidth needs. However, cacheable service information that is re-broadcast infrequently is not normally accessible to an existing installed population of receivers adapted only to receive carousel broadcasts.

An object of the invention is to provide a means by which a “primary”, cached information service can reference pages or extracts of content available from existing “secondary” broadcasts of carousel data. This is for the purpose of reusing the said secondary service contents without requiring that they be simulcast as part of the main cached service also.

According to the present invention, there is provided a television system comprising means for displaying a user interface, means in the interface for allowing a user to select additional information, means for receiving a user selection for additional information, the additional information being provided from a secondary broadcast, means for extracting the selected information and means for presenting the information to the user, preferably as part of the user interface.

Preferably, the user interface is an interactive electronic program guide. Preferably, the secondary broadcast is teletext or some other form of information service that broadcasts, for example, in the VBI. An advantage of this is that viewers can view, for example, teletext pages as part of the interactive program guide (IPG). This can be done whilst simultaneously viewing the currently viewed, television program in a portion of the IPG.

Preferably means are provided for searching for the selected information.

Preferably the means for allowing the user to select include interactive icons, for example offering additional information on sport or weather or news, etc. Preferably, the icons include links to the selected information in the secondary broadcasts.

According to another aspect of the present invention, there is provided an electronic program guide that is linked to information that is provided in a secondary broadcast, for example, teletext, the guide including means for allowing user selections of the information and means for causing information in the secondary broadcast to be displayed.

According to a further aspect of the present invention there is provided a television system comprising a display for displaying a user interface, a selector system in the interface for allowing a user to select additional information, a receiver for receiving a user selection of said additional information, the additional information being provided from a secondary broadcast, an extractor for extracting the selected information and a presentation system for presenting the information to the user.

According to a further aspect of the present invention there is provided An electronic program guide linked to information that is provided in a secondary broadcast, the guide having a selector system for allowing user selections of the information and a display for causing information in the secondary broadcast to be displayed.

In the embodiments described, the secondary services are from teletext services broadcast in the VBI of analogue PAL or SECAM TV broadcasts. However the invention may be readily applied also to other embodiments of secondary broadcasts for digital TV, such as defined by the DVB and ATSC broadcast bodies, that can receive and decode content encoded in MHEG-5, Java, HTML or other formats.

The invention further provides for a number of different means whereby secondary service data can be acquired to form parts of navigational menus, titles to content and the content itself. In each case a shell of data is received from the primary broadcast that reference text extracts contained in one or more secondary services.

The invention further provides for a number of different means whereby timing of downloading of the secondary service data is controlled so as to ensure that its content is always recent and up-to-date.

The information services are broadcast as a complementary service for reception by TV viewers in addition to TV. The preferred embodiment for information services broadcast in the VBI of an analogue broadcast is one where the primary cached information service is received alongside electronic programme guide listings data downloads that occur during approx. 3 to 4 download windows in each day of approx. 30 minutes duration each.

The preferred embodiment for information services broadcast within the MPEG2 data stream of a digital broadcast is also one where the primary cached information service is received alongside electronic programme guide listings data downloads that occur during approx. 3 to 4 downloads windows in each day of approx. 30 minutes duration each. However, in order to optimise digital transmission bandwidth in a manner advantageous to those purchasing digital broadcast bandwidth, the timing of these download windows may vary. Each periodic download is implemented using a digital broadcast carousel.

Preferred embodiments of the invention will now be described by way of example only, and with reference to the accompanying drawings in which:

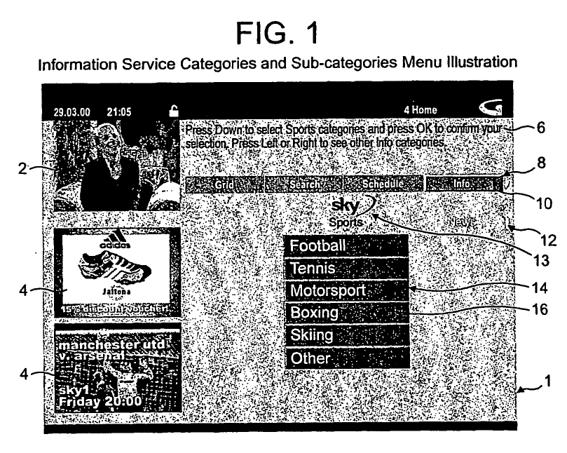

FIG. 1 illustrates an information service as it displayed on the TV viewer's screen;

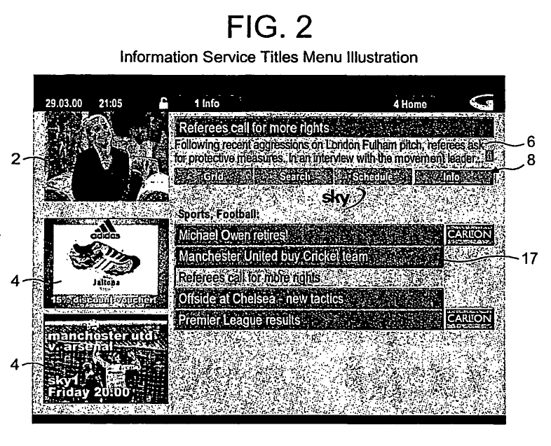

FIG. 2 illustrates a further information service page as it displayed on the TV viewer's screen;

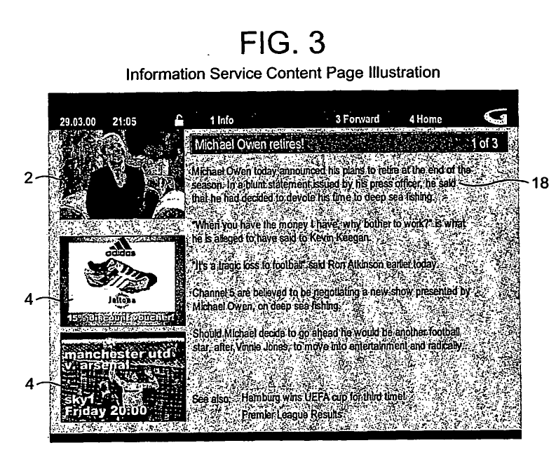

FIG. 3 illustrates another information service page as it displayed on the TV viewer's screen;

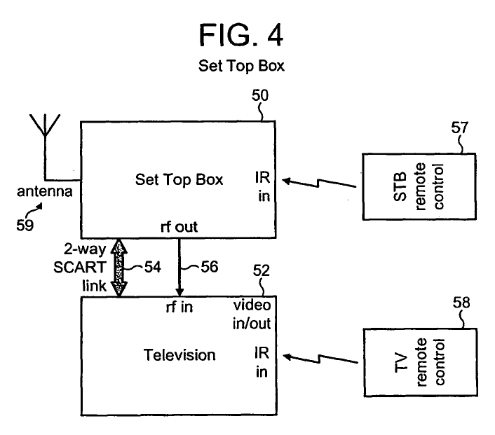

FIG. 4 shows a set-top-box (STB) that is used in conjunction with a television set to display the information service;

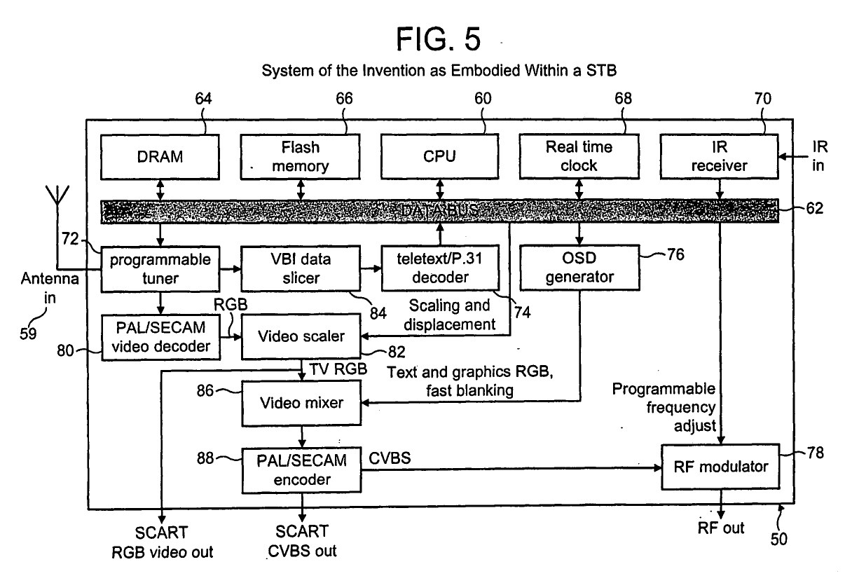

FIG. 5 illustrates the internal workings of the STB of FIG. 4;

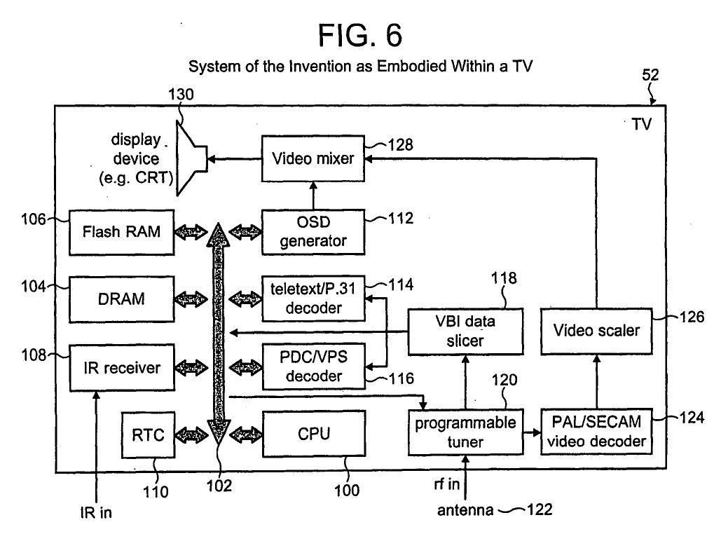

FIG. 6 is a block schematic of an analogue Vertical Blanking Interval system of the invention as embodied within a television receiver;

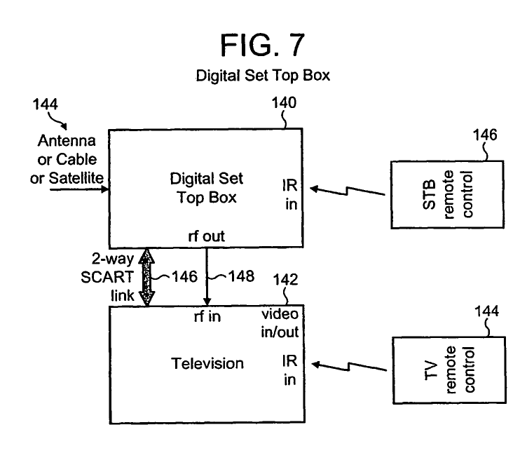

FIG. 7 shows a digital STB that is used in conjunction with a television (TV) set to display the service;

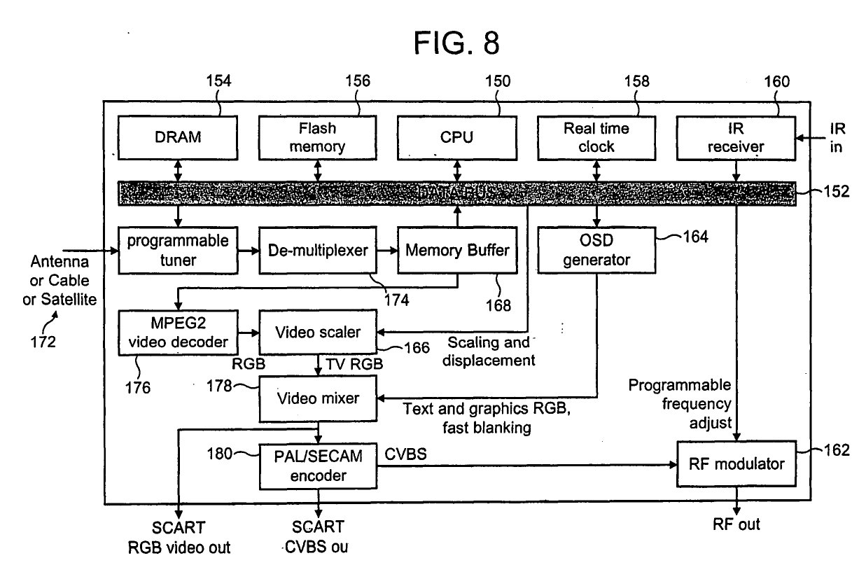

FIG. 8 is a block schematic showing the internal workings of the STB of FIG. 7;

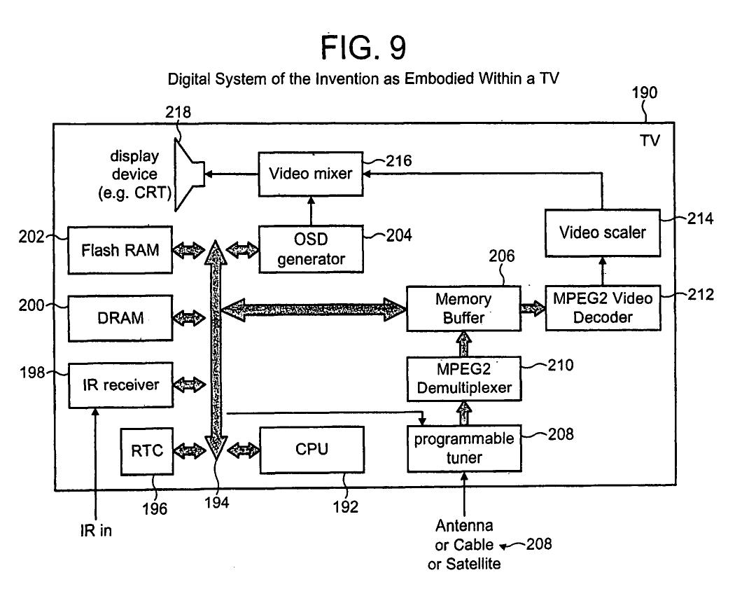

FIG. 9 is a block schematic showing a digital system embodying the invention within a TV receiver;

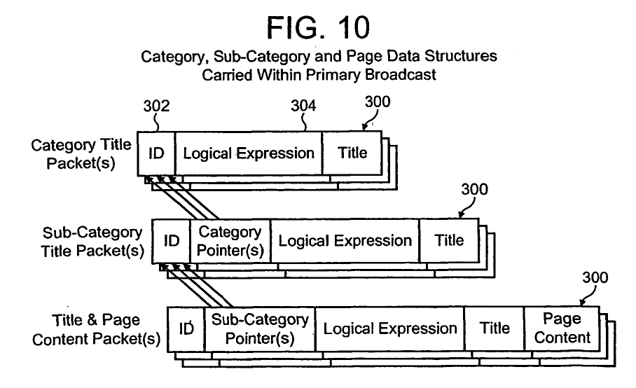

FIG. 10 shows the logical structure of data received by the system in the primary broadcast; and

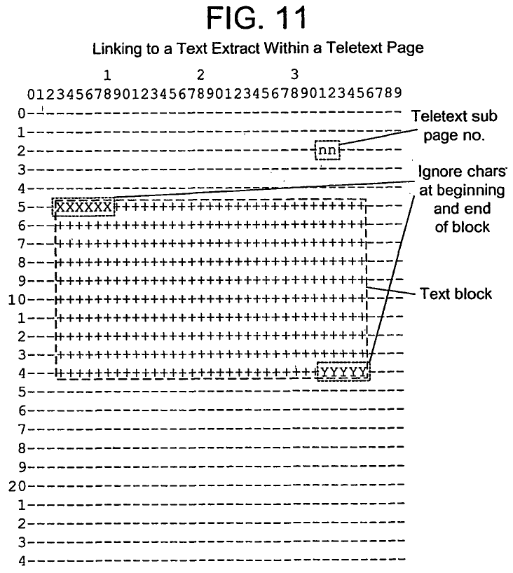

FIG. 11 shows the links in a text extract within a teletext page.

FIGS. 1 to 3 illustrate the information service as it displayed on the TV viewer's screen. In FIG. 1, the display 1 comprises a reduced scale television picture 2, a number of advertising panels 4, an information panel 6, a first menu panel 8 comprising a plurality of menu option cells 10, each cell 10 being allocated to a different menu option, a second menu panel 12 comprising a plurality of information service category cells 13, each cell 13 being allocated to a different information service category, and a sub-category panel 14 comprising a plurality of sub-category cells 16, each cell 16 having a sub-category label identifying the subcategory to which the cell relates.

By pressing left/right cursor keys on a remote keypad (not shown), a viewer may navigate between top level information service categories (such as “sports”, “weather” etc in FIG. 1). Use of the up/down cursor key navigates the viewer to sub-category labels 16 (such as “football”, “tennis” etc as shown in FIG. 1). The service menus given in the second menu panel 12 and the information set out in information panel 6 are displayed preferably alongside the reduced scaled TV picture 2 and/or advertising promotional panels 4 embedded in portions of the display, as shown in FIGS. 1 to 3.

Upon pressing a key to select a sub-category label 16, cells 17 containing content titles associated with this label are displayed as illustrated in FIG. 2.

The viewer has the option to navigate vertically among and highlight titles using the up/down cursor keys. Pressing a select key causes the content associated with the highlighted title to be displayed in a display panel 18, as illustrated in FIG. 3.

FIG. 4 shows a set-top-box (STB) 50 that is used in conjunction with a television (TV) set 52 to display the service. The STB 50 and TV 52 are connected using, for example, a two-way SCART link 54 and an RF link 56. Both the STB 50 and the TV 52 each have a remote control unit 57 and 58 respectively, to allow the user to operate the functions of the STB and the TV.

FIG. 5 illustrates the internal workings of the STB of FIG. 4 where both primary and secondary data are recovered from the VBI portion of an analogue broadcast signal. The STB 50 comprises a CPU 60 coupled to a data bus 62 through which the CPU 60 is connected to both volatile (“DRAM”)64 and non-volatile (“Flash”) memory 66, a real time clock 68, and infra red receiver 70. The infrared receiver takes signals from the STB remote control 57. The CPU 60 is also coupled, via the data bus 62 to programmable tuner 72, a teletext/P.31 decoder 74, an OSD generator 76 and an RF modulator 78. The RF modulator 78 provides an RF output to the TV set.

The programmable tuner 72 receives an incoming RF signal via the antenna 59 and is coupled to a PAL/SECAM video decoder 80, which provides RGB signals to a video scaler 82. The tuner 72 is also coupled to a VBI data slicer 84 which drives the teletext decoder 74 coupled to the data bus 62.

The video scaler 82 which receives scaling and displacement signals from the data bus 62 provides the TV RGB signals to the SCART link. These signals are also passed to a video mixer 86 where they are mixed with text and graphics RGB signals and fast blanking from the OSD generator 76. The video mixer 86 drives a PAL/SECAM encoder 88 which provides CVBS signals to the scart link and also to the RF modulator 78 which provides an RF output to the TV set. The frequency of the RF modulator 78 is adjusted by signals from the data bus 62.

The CPU 60 executes a firmware program within the Flash memory 66 that causes it to power up from standby and tune to, using the programmable TV tuner 72, information service broadcasts from a primary, cached broadcaster at a small number (typically between 2 and 6) of fixed download periods during each day.

Timing information controlling the downloads of text extracts from secondary broadcasts is contained within descriptors contained within the category, sub-category and page title packets that are downloaded from the primary broadcast—see later.

The timing of fetches of text extracts from secondary broadcasts, together with power ups from standby where necessary, is achieved by the CPU 60 periodically polling, or being interrupted by, the real-time-clock (RTC) 68. During a download period, the VBI portion of the video signal for each line in each video raster is converted to a bit stream by the VBI Data Slicer 84 and further decoded to extract the service data. In the embodiment described this is performed by decoding according to the WST Packet 31 IDL-A and IDL-B data formats. After decoding, this data is stored in DRAM 64 and/or Flash memory 66 and selectively processed as later described. The service is displayed by generating a video signal using the CPU 60 controlled On-Screen-Display generator and combining with the TV video signal before re-encoding and modulating to give an RF output or, alternatively/additionally, outputting directly in RGB or CVBS form to the TV via a SCART connector.

FIG. 6 describes the analogue VBI system of the invention as embodied within a TV receiver 52. The system comprises a CPU 100 connected to a data bus 102 which is coupled to volatile DRAM 104 and non-volatile flash memories 106, an IR receiver 108, a real time clock 110, an OSD generator 112, a teletext/P31 decoder 114 and a PDC/VPS decoder 116. The CPU 100 is also coupled, via the data bus 102 to a VBI data slicer 118 and a programmable tuner 120. The programmable tuner 120, whose frequency is set by the CPU 100 via the data bus .102, receives the RF signal from the antenna 122 and drives the VBI data slicer 118. It also drives the PAL/SECAM video decoder 124, the output of which drives a video scaler 126. The output of the video scaler 126 drives a video mixer 128. The video mixer 128 mixes the output of the video scaler 126 with the output of the OSD generator 112 to produce the signal for the display device 130. The VBI data slicer 118 drives the teletext decoder 114, PDC/VPS decoder 116 and also provides signals to the data bus 102.

Substantial re-use of common TV components such as a programmable tuner, a PAL/SECAM decoder, an OSD generator, and teletext data slicer and decoder is possible in the system of FIG. 6.

FIG. 7 shows a digital STB 140 that is used in conjunction with a television (TV) 142 set to display the service. The incoming signal is received from the antenna, or via cable or satellite 144. Two outputs are provided to the TV set, one via a two-way scart link 146 and the other via an RF signal 148. Both the TV 142 and the STB 140 are controlled by remote control units 144 and 146 coupled via IR links.

FIG. 8 illustrates the internal workings of the STB 140 of FIG. 7 where both primary and secondary data are recovered from one or more elementary data streams (PID streams) of a digital broadcast received on the antenna (DTT), cable or satellite link 172. The STB 140 comprises a CPU 150 coupled to a data bus 152 which is also coupled to both volatile (“DRAM”) 154 and non-volatile (“Flash”) memories 156, a real time clock 158, an IR receiver 160, an RF modulator 162, an OSD generator 164, a video scaler 166, a memory buffer 168 and a programmable tuner 170. The programmable tuner 170 is tuned by the CPU 150 via the data bus 152 to select the signal received from the antenna, cable or satellite 172 link. The output of the programmable tuner 170 is passed to a demultiplexer 174 and thence to a memory buffer 168 which provides signals to the data bus 152 and also to a video decoder 176. The RGB output of the video decoder 176 is fed to a video scaler 166 where it is scaled by signals from the data bus 152. The output of the video scaler 166 provides the RGB video signals to a video mixer 178. The video mixer 178 combines the TV RGB signals with the text and graphics RGB signals and fast blanking from the OSD generator 164. The output of the video mixer 178 provides the RGB video signals to the SCART link and the output is also fed to a PAL/SECAM encoder 180, the CVBS output of which is fed to the SCART link and also the RF modulator 162 to provide an RF output to the TV set.

The CPU 150 executes a firmware program within the Flash memory 156 that causes the STB to power up from standby and tune to, using the programmable TV tuner 170, information service broadcasts from a primary, cached broadcaster at a small number (typically between 2 and 6) of fixed download periods during each day.

Timing information controlling the downloads of text extracts from secondary broadcasts is contained within descriptors contained within the category, sub-category and page title packets that are downloaded from the primary broadcast. This is the same for both analogue VBI and digital implementations—see later.

As with the analogue VBI implementation, in the digital implementation, the timing of fetches of text extracts from secondary broadcasts, together with power ups from standby where necessary, is achieved by the CPU 150 periodically polling, or being interrupted by, the real-time-clock (RTC) 158. During a download period, the service data is extracted from an elementary data stream contained within the digital broadcast using the demultiplexer 174 with the digital STB. After decoding, this data is stored in DRAM 154 and/or Flash 156 memory and selectively processed as later described. The service is displayed by generating a video signal using the CPU 150 controlled On-Screen-Display (OSD) 164 generator and combining with the TV video signal before re-encoding and modulating to give an RF output or, alternatively/additionally, outputting directly in RGB or CVBS form to the TV via a SCART connector.

FIG. 9 shows a digital embodiment of the invention as incorporated within a TV receiver 190, where the same system components are also present as in the STB of FIG. 8 except that substantial re-use of common TV components such as programmable tuner, OSD generator and demultiplexer is possible.

The system 190 of FIG. 9 comprises a CPU 192 coupled to a data bus 194. A real time clock 196, an IR receiver 198, a volatile DRAM 200, a non-volatile flash RAM memory 202, an OSD generator 204, a memory buffer 206, and a programmable tuner 208 are also coupled to the data bus 194. The programmable tuner 208 selects, according to instructions provided by the CPU 192 via the data bus 194, the incoming signal from the antenna/cable/satellite 208. The output is passed to a demultiplexer 210 and thence to the memory buffer 206. The memory buffer 206 drives a video decoder 212 to produce a signal which drives a video scaler 214, the output of which is combined with the output of the OSD generator 204 in a video mixer 216 to produce a signal to drive the display device 218.

FIG. 10 shows the logical structure of data received by the system in the primary broadcast: one or more “category title” packets 300 are broadcast for each top level information category (such as “sports”, “weather” etc in FIG. 1). Each packet 300 contains a unique identifier (ID) 302 and a logical expression 304 in a device independent, tokenized form that contains boolean and/or arithmetic functions of constants and/or data variables within the system. For example, an expression may be “POSTCODE=‘SL*’ AND LANGUAGE=‘ENGLISH’”, and which would be evaluated as logical true in cases where the user has configured the system to display the English language and is located within postcode regions whose first 2 characters are “SL”. Many additional working variables in addition to POSTCODE and LANGUAGE may be referenced. A received category title packet is stored immediately it is received into buffer area within DRAM, where its logical expression is evaluated. If the expression is evaluated as FALSE, the whole packet is erased from the buffer—otherwise it is written to flash.

Each category title packet contains a “Title” comprising a string of text or tokens which, optionally, may contain delimited within it references to one or more “text links”. A text link is a reference to an extract of text to be found in a page from a secondary teletext broadcast and contains reference to:

the Channel Network Identifier (CNI) for the TV channel on which the teletext service is to be found in the case of the analogue VBI implementation, OR the transport stream and elementary stream identifier (PID) for the MPEG2 data stream carrying the digital implementation of the teletext service;

the teletext service's magazine, page and sub-page number on which the extract of text is to be found;

timing parameters that prescribe when to download the text extract from the secondary broadcast. These timings may be either:

immediately after the download of the cached data from the primary broadcast while the system is in standby and not in use by a viewer (a so called “post preload link”) or;

between a specific time window (a “scheduled link”), or;

during a live user session when a title is to be displayed, causing the TV sound to mute and picture to be frozen during the download (a “live, channel locked link”) and to unfreeze and restore the TV picture and sound on the original channel to which the TV was tuned when the download is completed, or;

during a live user session when a title is to be displayed, causing the TV sound and picture to change to the TV of the secondary channel from the beginning of the download (a “live, channel unlocked link”) and for TV to remain tuned to this channel when the download is completed;

the expected average wait and download time for the text extract;

row and column co-ordinates for a rectangle within a teletext page, defining where the extract of text is to be found. This is illustrated in FIG. 11 where the 40 columns and 25 rows in a standard page are shown, with an example of a rectangular block depicted by these parameters;

two integers, X and Y (see FIG. 11), depicting that the first X and last Y characters in the rectangular block be ignored and not extracted;

a maximum timeout time, after which the link will be abandoned if the specified sub-page is not found;

on-screen text error message for display if the text extract could not be downloaded (i.e. because a channel with the CNI could not be found or because a timeout occurred during download).

Upon completion of the download from the primary broadcast, the system reads the timing indicators in each saved packet to determine whether text extracts referenced by a link are to be downloaded immediately or at specified times. As soon as the specified time for a text link is satisfied the system causes the programmable tuner to change to the frequency corresponding to the CNI referenced by the link.

One or more of each of the “Sub-category title” and “Title & page content title” packets illustrated in FIG. 10 are received by the system from the primary broadcast. Each of both types of packet contain one or more pointer references to the identifiers (“ID”) of the Category title and Sub-category title packets respectively. Both types of packets are written to DRAM buffer memory, where their pointers are checked to ensure that they refer to a valid higher level packet that has been downloaded. The packet is erased if none of its pointer references can be satisfied. Each packet's logical expression is evaluated to determine whether it is to be saved in flash memory or erased. Both contain title fields may optionally contain text links as already described for Category title packets. Additionally, “Title & page content” packets contain page text content (as illustrated in FIG. 3) which, optionally, may also contain text links.

During a usage session, the viewer selects information service by highlighting and selecting a graphic button depicting this mode displayed on the graphical user interface (the “Info” button illustrated in FIG. 1). In response, the system retrieves the category and sub-category titles from flash memory and display them on the screen, attempting where optionally required to satisfy any live text links contained within the titles. When a user highlights and selects a sub-category title, the system retrieves and displays the titles (see FIG. 2) that point to this selected sub-category from flash memory, attempting where optionally required to satisfy any live text links contained within these titles also. Additionally, the logo of the channel correspond to secondary broadcast channel and/or the expected delay time may be displayed next to the title or in another area. Finally, the user selects and highlights a page title which causes the system to display the content page(s) directly associated with the page title, satisfying and displaying text extracts from live text links before or while doing so.

A skilled person will appreciate that variations of the disclosed arrangements are possible without departing from the invention. Accordingly, the above description of several embodiments is made by way of example and not for the purposes of limitation. It will be clear to the skilled person that minor modifications can be made without significant changes to the operation described above.

1. A television system comprising means for displaying a user interface, means in the interface for allowing a user to select additional information, means for receiving a user selection of said additional information, the additional information being provided from a secondary broadcast, means for extracting the selected information and means for presenting the information to the user.

2. A television system according to claim 1, wherein the means for presenting the information to the user is adapted to present the information as part of the user interface.

3. A television system according to claim 1 or 2, wherein the user interface is an interactive electronic program guide.

4. A television system according to any preceding claim, wherein, the secondary broadcast is teletext.

5. A television system according to any preceding claim, wherein, the secondary broadcast is a form of information service that broadcasts in the VBI of an analogue PAL or SECAM broadcast OR in a private data stream contained in an MPEG2 digital broadcast.

6. A television system according to any preceding claim, wherein means are provided for searching for the selected information.

7. A television system according to any preceding claim, wherein the means for allowing the user to select include interactive icons.

8. A television system according to claim 7, wherein the interactive icons offer additional information on a topic.

9. A television system according to any of claims 6 to 8, wherein the icons include links to the selected information in the secondary broadcasts.

10. An electronic program guide linked to information that is provided in a secondary broadcast, the guide having means for allowing user selections of the information and means for causing information in the secondary broadcast to be displayed.

11. A television system according to any preceding claim, wherein the secondary services are from teletext services broadcast in the VBI of analogue PAL or SECAM TV broadcasts.

12. A television system according to any preceding claim, wherein the secondary broadcasts are from teletext services encoded to DVB Teletext Extensions standard ETSI EN 300 472 v1.2.2 or other encoding standards and broadcast in private data sections of an MPEG2 digital TV broadcast.

13. A television system according to claim 12, wherein the secondary broadcasts for digital TV can receive and decode encoded content encoded in MHEG-5, Java, or HTM formats.

14. A television system comprising a display for displaying a user interface, a selector system in the interface for allowing a user to select additional information, a receiver for receiving a user selection of said additional information, the additional information being provided from a secondary broadcast, an extractor for extracting the selected information and a presentation system for presenting the information to the user.

15. A television system according to claim 14, wherein the presentation system for presenting the information to the user is adapted to present the information as part of the user interface.

16. A television system according to claim 14, wherein the user interface is an interactive electronic program guide.

17. A television system according to claim 14, wherein the secondary broadcast is teletext.

18. A television system according to claim 14, wherein the secondary broadcast is an information service that broadcasts, for example, in the VBI of an analogue PAL or SECAM TV broadcast or as private data sections in an MPEG2 digital broadcast.

19. A television system according to claim 14, further comprising a searching system for searching for the selected information.

20. A television system according to a claim 14, wherein the selector for allowing the user to select includes interactive icons.

21. A television system according to a claim 20, wherein the interactive icons are designed to offer additional information on a topic.

22. A television system according to claim 20, wherein the icons include links to the selected information in the secondary broadcasts.

23. An electronic program guide linked to information that is provided in a secondary broadcast, the guide having a selector system for allowing user selections of the information and a display for causing information in the secondary broadcast to be displayed.

24. A television system according to claim 14, wherein the secondary services are from teletext services broadcast in the VBI of analogue PAL or SECAM TV broadcasts.

25. A television system according to claim 14, wherein the secondary services are from teletext services encoded to DVB Teletext Extensions standard ETSI EN 300 472 v1.2.2 or other encoding standards and broadcast in private data sections of an MPEG2 digital TV broadcast.

26. A television system according to claim 25, wherein the secondary broadcasts for digital TV is adapted to receive and decode content encoded in MHMG-5, Java, or HTML format.
